(19) United States
(12) Patent Application Publication
(10) Pub. No.: US 2023/0189756 A1
(43) Pub. Date: Jun. 22, 2023

(54) Water Bowl Connectable to Drip Irrigation System and Emitter Therefor

(71) Applicant: LuckyChoco, LLC, Scottsdale, AZ (US)

(72) Inventors: Sandra L Etherton, Scottsdale, AZ (US); Timothy A Wakefield, JR., Brandon, SD (US)

(73) Assignee: LuckyChoco, LLC, Scottsdale, AZ (US)

(21) Appl. No.: 18/111,788

(22) Filed: Feb. 20, 2023

Related U.S. Application Data
(62) Division of application No. 15/850,011, filed on Dec. 21, 2017, now abandoned.
(60) Provisional application No. 62/438,378, filed on Dec. 22, 2016.
(60) Provisional application No. 62/466,282, filed on Mar. 2, 2017.

(51) Int. Cl. A01K 7/02; A01K 7/00; A01G 27/00; B05B 17/08

(52) U.S. Cl. CPC A01K 7/02; A01K 7/005; A01G 27/005; B05B 17/08

(57) ABSTRACT

A bowl is attached to a drip irrigation system at an emitter, so that the bowl can be filled with water in an automated fashion, using the control timer and solenoid valves of the existing irrigation system. The emitter has a stem and a head. The stem extends through a hole in the sidewall of the bowl so that the head rests against the sidewall of the bowl. Preferably the head is flush with the sidewall of the bowl and forms a water-tight seal with the sidewall of the bowl. Drip irrigation tubing is attached to the stem of the emitter and connected to the drip irrigation system. A through-hole runs through the emitter to permit water to flow from the drip irrigation tubing through the stem and head into the bowl. An in-line valve between the water source and the emitter improves control of the water through the emitter.

### CROSS-REFERENCE TO RELATED APPLICATIONS

This application is a divisional of and claims the benefit of U.S. application Ser. No. 15/850,011 filed Dec. 21, 2017, which claims the benefit of U.S. Provisional Applications Nos. 62/438378 filed Dec. 22, 2016 and 62/466282 filed on Mar. 2, 2017.

### FIELD OF INVENTION

This invention relates to pet watering devices. This invention relates particularly to an apparatus that fills a water bowl using a drip irrigation system.

### BACKGROUND

People who own pets have to make sure the pets have a source of water. Typically this means filling a water bowl daily, either indoors from a faucet or outdoors from a hose. For outdoor pets, water bowls are known that attach directly or indirectly to a hose bib on the house so that the owner can turn on the spigot and fill the bowl from the pressurized house water supply. These systems require human action to fill the bowl, which is problematic because there's always the risk that the pet owner will forget to fill the bowl. In hot climates, even a few hours outside without water puts a pet's life at risk. To ensure the pet always has a bowl full of water, some bowls use a float valve that permits water to flow into the bowl from the pressurized house water supply once the water level drops, much like a toilet. One disadvantage of these systems for outdoor bowls attached to hose-bibs is that, because typically each home or building has only one hose bib on the side of a house, the occupied hose bib can't be used for garden hoses or other uses. That, in turn, means the bowl has to be disconnected to permit the hose bib to be used for other purposes, which again risks forgetting to reconnect it and leaving the pet without water. It would be desirable to have an outdoor water bowl that fills regularly without human intervention.

Once installed and set properly, a drip irrigation system is a source of water that works without human intervention. The water in the drip irrigation system is under pressure from a mains water source and, unless impeded by valves or other pressure-reducing devices, flows freely through the system. The system distributes water through a network of valves, tubing, and emitters, mostly underground, and uses a control timer connected to one or more solenoid on-off valves that are connected to the pressurized water supply. The solenoid valves are also connected to ½′ diameter irrigation pipes or tubing through which water is directed to the desired location in the garden, yard or flower pots. The control timer is set to turn the solenoid valves on or off at desired times and for desired periods throughout the day, permitting or prohibiting the pressurized water from the mains to flow into the attached irrigation tubing, ensuring the desired amount of water gets to the desired location. Along the irrigation tubing are various emitters, ranging from high-volume rotary sprinkler heads to low-flow emitters. Typically the low-flow emitters are connected to the ½′ irrigation tubing with ¼″ diameter irrigation tubing, known as drip line. The emitter diverts a relatively small portion of water flowing in the irrigation tubing and discharges the diverted water to irrigate plants in flower pots or on the ground near the location of the emitter. Common drip emitters emit about 0.5-4.0 gallons per hour, whereas a garden hose generally emits about 2-5 gallons per minute. The low-flow emitters use various mechanical means to reduce the water pressure and flow rate so that the volume of emitted water can be closely controlled, preventing water from being wasted through over-watering, splashing, and evaporation.

It would be desirable to connect a pet watering bowl to a drip irrigation system to ensure outdoor pets have a trusted source of water. One difficulty, however, is that known drip irrigation system emitters do not securely or easily attach to a bowl. Without direct attachment to the bowl, the emitters fall off or out of the bowl and the pet owner cannot be certain the bowl will be filled with water. It would be desirable to securely connect a drip emitter to a bowl. Another problem is that, whether from thirst or for entertainment, dogs love to chew drip emitters, biting the heads off the emitters and causing the water to be emitted at nearly full pressure from the now-open ¼″ drip line. It would be desirable to provide a drip emitter that pets cannot easily chew and that does not spray water in a chew-enticing way.

### SUMMARY OF THE INVENTION

An emitter is disposed in the sidewall of a bowl. The inlet of the emitter receives water from a pressurized water source, preferably a drip irrigation system, and the outlet of the emitter emits water into the bowl. In this way the water bowl can be filled in an automated fashion, using the control timer and on-off valves of the existing irrigation system. The emitter has a stem and a head. Drip irrigation tubing is attached to the stem of the emitter and connected to the drip irrigation system. A through hole runs through the emitter to permit water to flow from the drip irrigation tubing through the stem and the head into the bowl. The through hole is preferably a pressure-reducing channel. Mechanisms to reduce pressure include decreasing the diameter of the channel from the inlet to the outlet, having a smaller diameter outlet aperture than the diameter of the through-hole at the inlet, or a employing a tortuous-path channel in the emitter. An adjustable valve may be disposed between the water source and the emitter to improve control of the flow rate of the water through the emitter. The emitter is preferably made of a resilient material such that the emitter resiliently seals against the sidewall to form a leak-tight seal.

### BRIEF DESCRIPTION OF THE DRAWINGS

FIG. 1 is a top perspective view of a water bowl of the present invention.

FIG. 2 is a bottom view of a water bowl of the present invention.

FIG. 3 is a cross-sectional view of a water bowl of the present invention along line 3-3 of FIG. 2.

FIG. 4 illustrates a water bowl attached to a drip irrigation system.

FIG. 5 is a top view of the water bowl of FIG. 1.

FIG. 6A is a front view of a flower-shaped emitter of the present invention.

FIG. 6B is a front view of an egg-shaped emitter of the present invention.

FIG. 7 is a perspective view of a dog bone-shaped emitter.

FIG. 8 is a front view of the dog bone-shaped emitter of FIG. 7.

FIG. 9 is a side view of the dog bone-shaped emitter of FIG. 7.

FIG. 10 is an end view of the dog bone-shaped emitter of FIG. 7.

FIG. 11 is a top perspective view of the dog bone-shaped emitter of FIG. 7 in a water bowl.

FIG. 12 is a side view of a water bowl with the drip line exiting through an aperture in the apron of the water bowl.

FIG. 13 is a side view of a water bowl with the drip line exiting through a cutout in the edge of the apron of the water bowl.

FIG. 14 is a side view of a water bowl with stakes to secure the bowl in the ground and a helical wire covering the drip line.

FIG. 15 illustrates a side view of an emitter attached to a bowl with fasteners.

FIG. 16 illustrates a side view of an alternative embodiment of the emitter having a tortious-path channel, attached to a bowl with fasteners.

FIG. 17A illustrates a cross-sectional view of a tortuous-path emitter having a flat, cone-shaped head.

FIG. 17B illustrates a cross-sectional view of a tortuous-path emitter having a concave, cone-shaped head.

FIG. 17C illustrates a cross-sectional view of a tortuous-path emitter having a tunable flow control, cone-shaped head.

FIG. 17D illustrates a top view of an adjustable flow control cap.

FIG. 18 is a side view of an emitter having a channel of decreasing diameter.

FIG. 19 is a cross section of the emitter of FIG. 18.

FIG. 20 illustrates an emitter with an interchangeable core for tunable flow control.

FIG. 21 illustrates a water bowl with an emitter molded in the sidewall of the bowl.

### DETAILED DESCRIPTION OF THE INVENTION

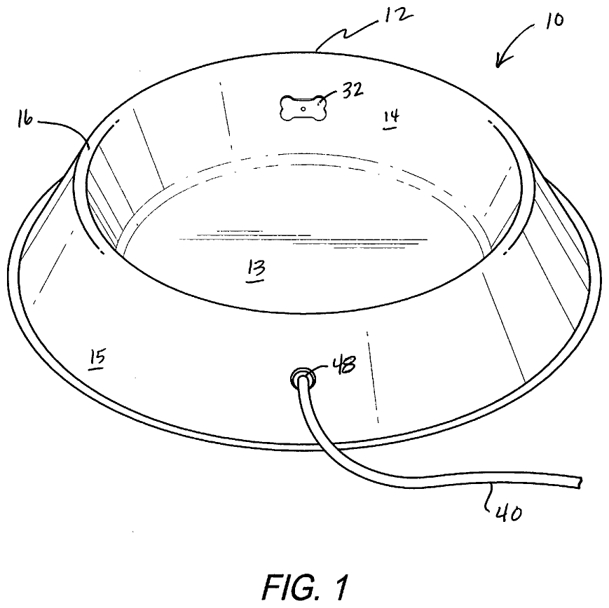

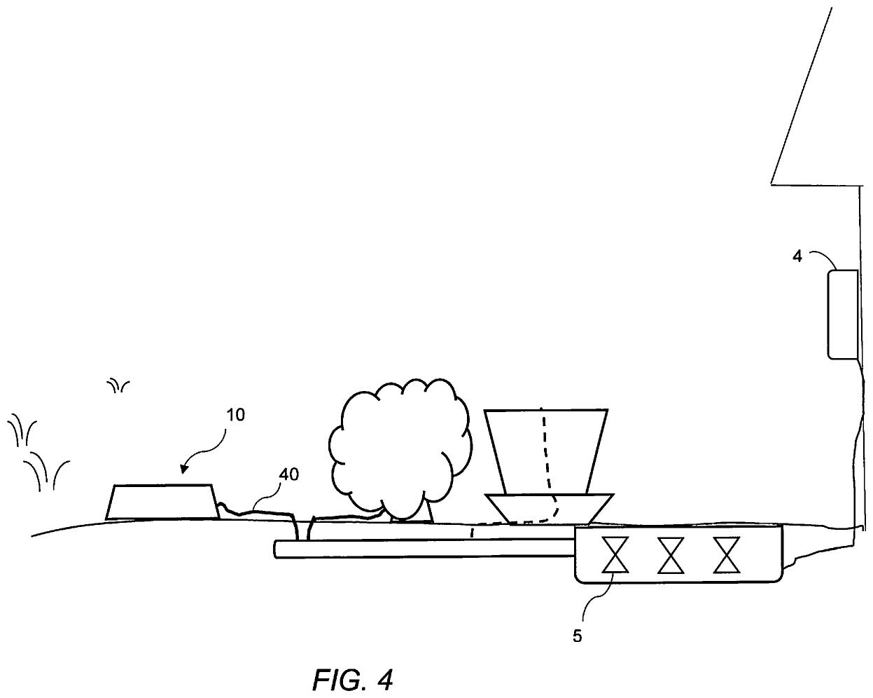

A water bowl 10 comprises an emitter 11 that attaches to a bowl 12, so that the bowl can be filled with water in an automated fashion from a pressurized drip irrigation system. Drip irrigation systems are known in the prior art and utilize a control timer 4 and solenoid on-off valves 5 to deliver water through the emitter 11 to the bowl 12 at desired times and volumes. See FIGS. 1 and 4.

Each bowl 12 has a sidewall 14 and a bottom 13. In some embodiments the bowl 12 has an apron 15 attached at the top edge 16 of the bowl. The apron 15 is a frustum of a cone with the major edge of the cone extending to the floor or ground, which prevents the bowl from skidding or tipping. The apron 15 also forms a cavity 17 between the sidewall 14 and the apron 15. FIGS. 1-3, 5, 11-14 show a bowl 12 with an apron and FIG. 21 shows a bowl without an apron. Typically the top edge 16 is planar, without recesses or scallops through which water can spill out of the bowl 12 below the top edge 16. The rim 18 of the apron 15 may be upturned to catch water that spills over the top edge 16 of the bowl 12.

The emitter is 11 configured to be fitted into the sidewall 14 of the bowl 12 in an emitter aperture 30. The inlet of the emitter 11 receives water from the pressurized water source and the outlet of the emitter emits water into the bowl 12. Preferably the emitter 11 reduces the flow rate of the water between the inlet and outlet. A preferred emitter is one that emits a regulated, small volume of water into the bowl when the irrigation system is on so that water fills the bowl slowly, keeping the water surface as still as possible, without overfilling the bowl or causing water to spray. Avoiding spillage makes the water bowl suitable for use on patios and porches. Avoiding spray makes the water flow less entertaining for pets, which in turn reduces the likelihood they will try to chew on the emitter. Preferably the emitter discharges water at a very uniform low rate under a wide range of water pressures.

To control the rate at which water is discharged by the emitter, the through hole 23 in the emitter may be a flow-restricting path that functions as a pressure-reduction channel, in which the pressure of water flowing through the emitter drops relatively rapidly with distance along the path. The pressure drop is from a relatively high water pressure at the emitter inlet (a steady high-volume flow), to a relatively low discharge pressure at the outlet (a trickle or intermittent drops of water), generally having a gauge pressure near zero at the outlet.

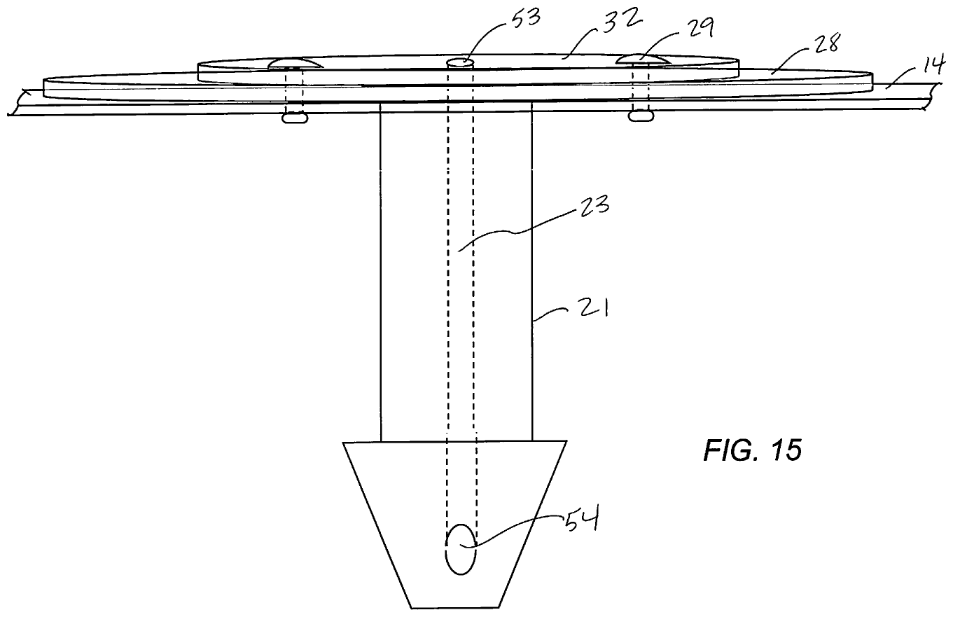

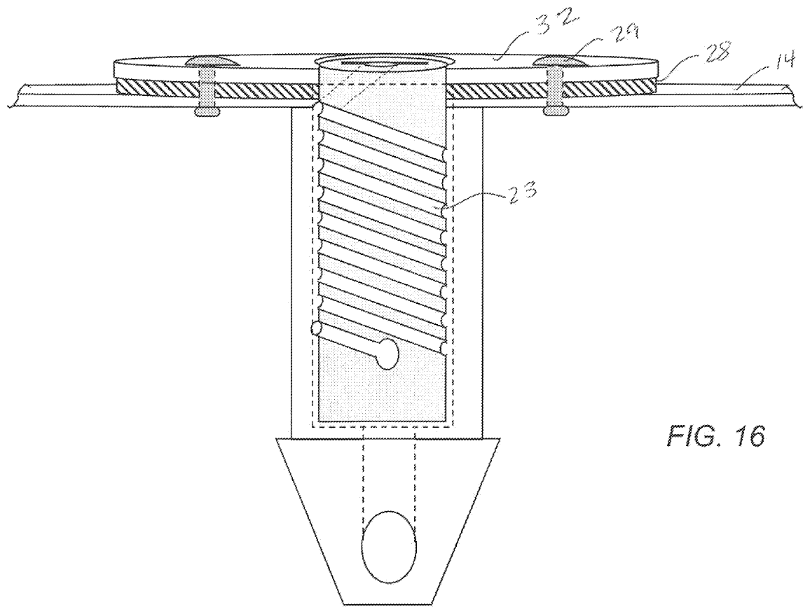

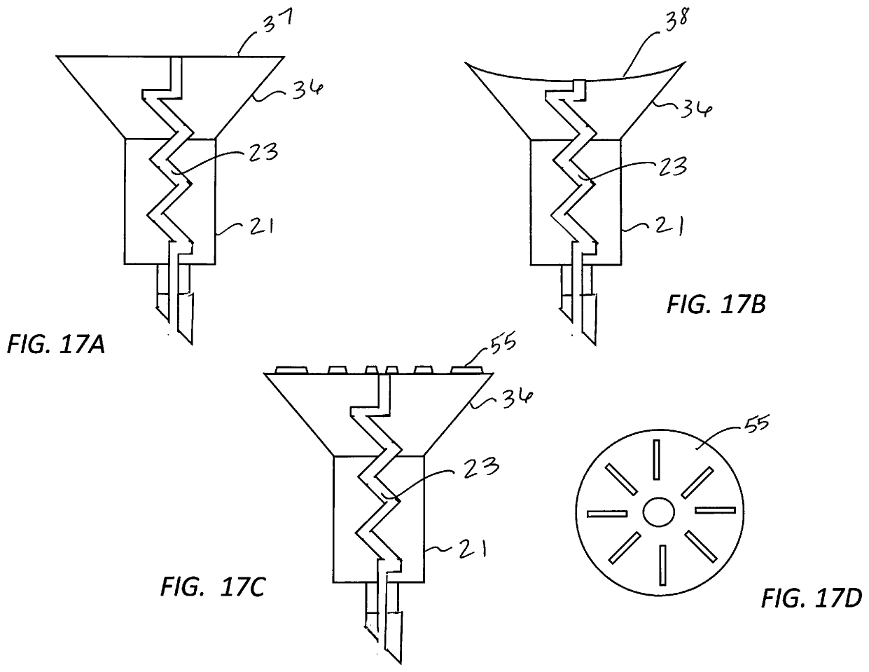

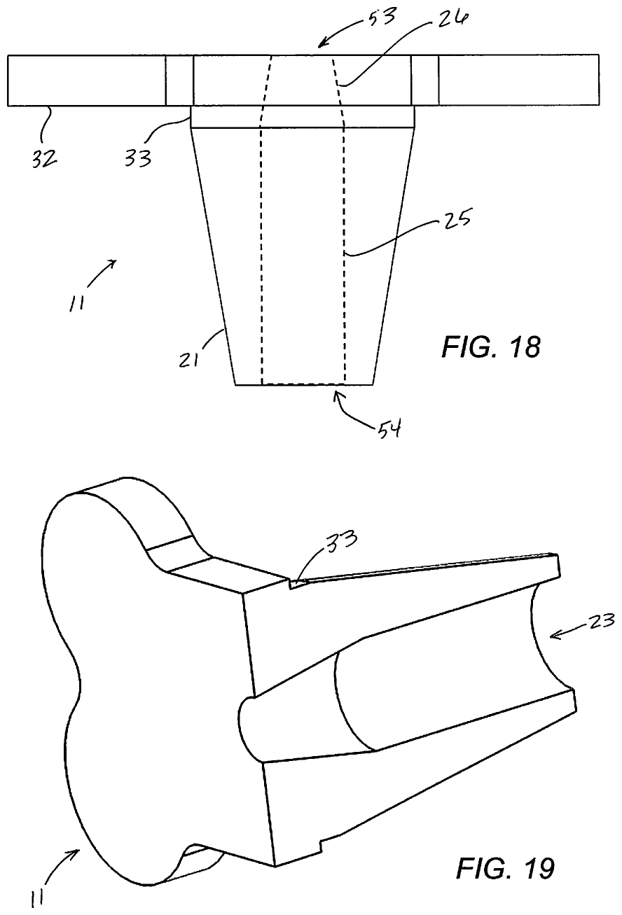

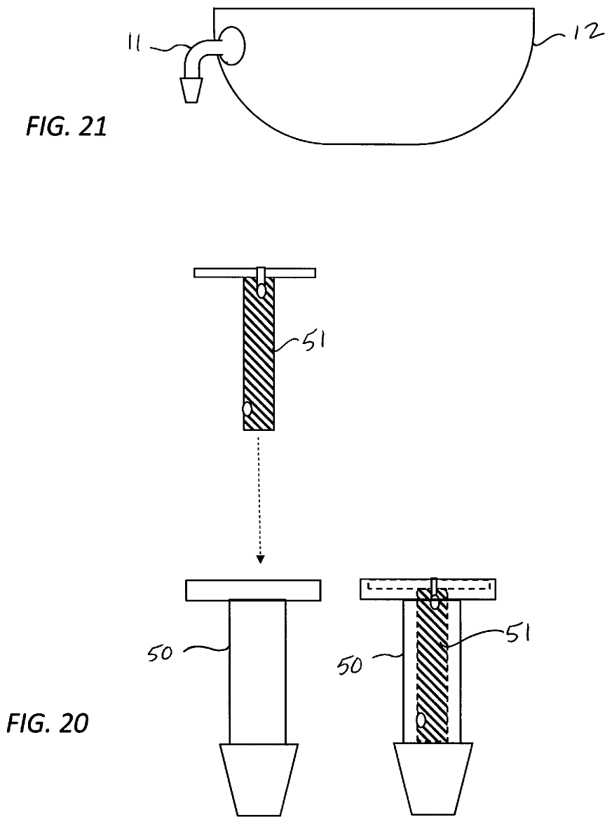

The pressure reduction can be achieved by several different mechanisms, which can be used alone or in combination. FIG. 15 illustrates a straight through hole 23 of constant diameter, in which the diameter of the aperture 53 at the outlet is smaller than the diameter of the aperture 54 of the inlet. FIG. 16 illustrates a through hole 23 that circles around and around a barrel shaped core. The small diameter and great length of this path reduces the water pressure and creates a more uniform flow. FIGS. 17A-C illustrate emitters having a labyrinthine channel, referred to herein as a tortuous-path through hole 23. Another mechanism for reducing flow rate is an adjustable cap 55 on the emitter at the outlet, which can be turned to open and close apertures in the emitter or lengthen or shorten the channel. See FIGS. 17C-D. FIGS. 18 and 19 illustrate the through channel 23 comprising a straight 24 portion and a conical portion 25 as it approaches the outlet. Another version narrows at a uniform rate along the channel, forming a cone-shaped channel that is wider at the inlet and narrower at the outlet. FIG. 20 illustrates a two-part emitter having a shell 50 with interchangeable cores 51, in which each core has a tortuous path of different length. This enables the user to change the flow rate of the emitted water by replacing one core with another. Another type of emitter is a vortex emitter which is configured to force the water around the outlet, causing a drop in pressure and lower flow through the outlet. Drip emitters may also include a resiliently flexible membrane or diaphragm located between the inlet and the outlet. In response to increase in pressure of the entering water, the membrane flexes into an adjacent pressure-regulating chamber to restrict the flow of water exiting the outlet.

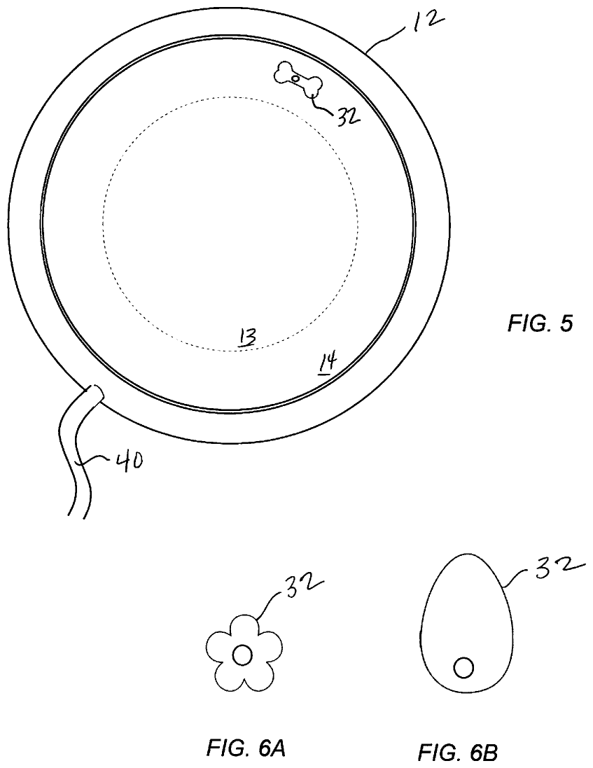

The emitter 11 is connected to the bowl 12 and may be integral with it. It can be attached to the bowl by mechanical means such as with a clip that attaches it to the bowl, or a hook that dangles the emitter over the side of the bowl. In the preferred embodiment, the emitter is disposed in an emitter aperture 30 in the sidewall 14 of the bowl. A leak-tight seal is formed at the intersection of the emitter and the sidewall of the bowl. This prevents water from leaking out of the bowl when the water level is above the emitter. In a preferred embodiment, the emitter is configured to be fitted into the sidewall 14 so that the head of the emitter is flush or nearly flush with the sidewall 14 or bottom 13 of the bowl 12. Being flush or nearly flush helps keep a pet from chewing on the emitter. As used herein, flush means even with the water-facing surface of the bowl's sidewall such that the water-facing surface of the bowl and the emitter form a single smooth surface. Nearly flush means the emitter forms a small ridge or valley relative to the water-facing surface of the bowl. The water-facing surface sidewall may be recessed to receive the emitter in a flush fashion. The head of the emitter may have a decorative shape, such as that of a dog bone particularly appropriate to apply to the inside of a dog bowl, a flower for inside a flower pot, or an egg for inside of a bird bath. See FIGS. 5, 6A-B.

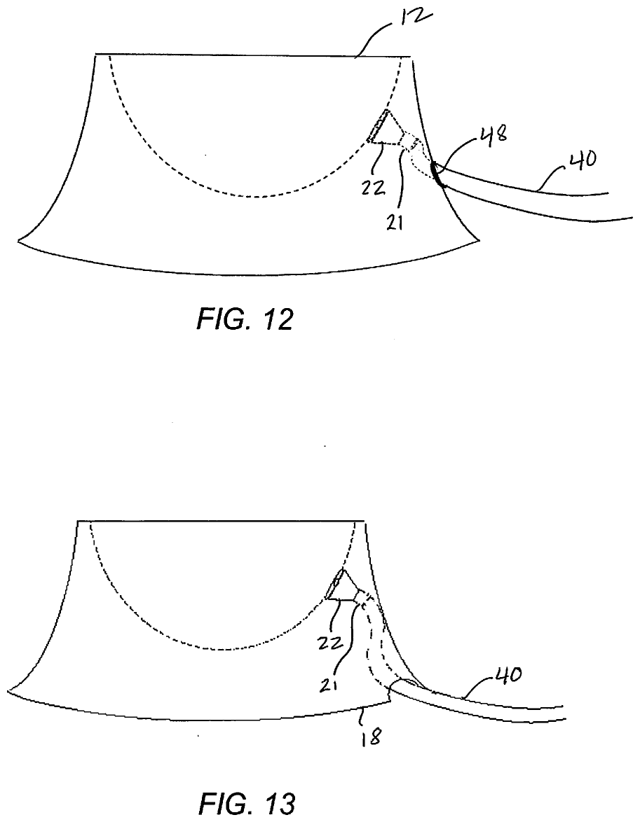

In one embodiment the emitter is made flush with the sidewall of the bowl by creating a chamfered hole in the sidewall of the bowl to receive a cone-shaped emitter head 36 on a straight-walled stem 21. See FIGS. 12 and 13. In another embodiment the hole is not chamfered but has straight sides, and the emitter has a cylindrical head on a straight-walled stem 21. See FIGS. 15 and 16. The emitter is held in place by friction, snap fit, by twisting ears attached to the side of the head into mated cleats in the hole, screwing it into mated threads in the hole, or other means. For example, the emitter may be attached to the bowl by rivets 29, adhered to it, or welded or brazed to it. To prevent leaks, the emitter may be cushioned by washers 28, gaskets, or o-rings on the inside or outside of the sidewall, which form a seal between the emitter and sidewall.

The emitter may have a flat head 37, such as shown in FIG. 17A, which if the sides of a bowl are not too curved, may fit closely enough for the head to be nearly flush with the bowl. Alternatively, the emitter may have a concave head 38, such as shown in FIG. 17B. Preferably the head is rigid plastic and is formed so that the curvature of the head matches or nearly matches the curvature of the sidewall of the bowl. In another embodiment the portion of the head that mates with the sidewall of the bowl is a flexible material such as plastic or rubber that conforms to the sidewall of the bowl. This flexible material may also function as a seal between the emitter and the bowl to prevent water from leaking out between the emitter and the bowl. In another embodiment, the emitter is molded into the bowl. See FIG. 21.

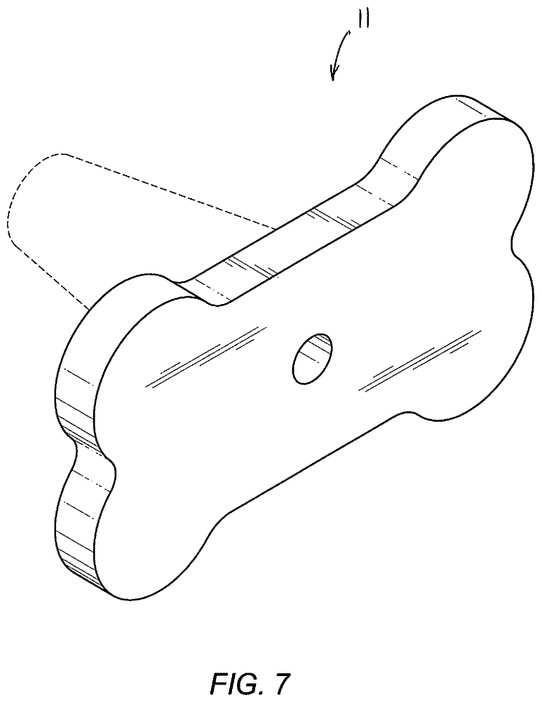

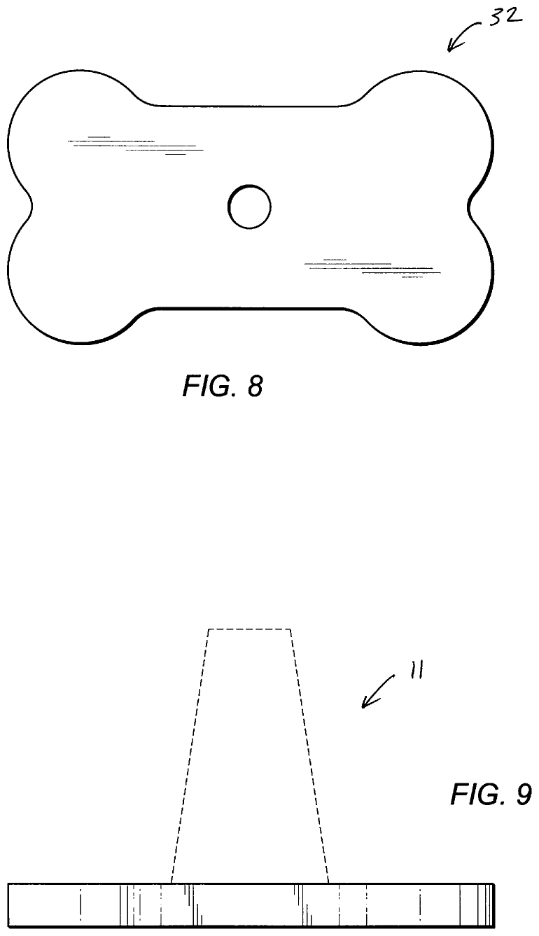

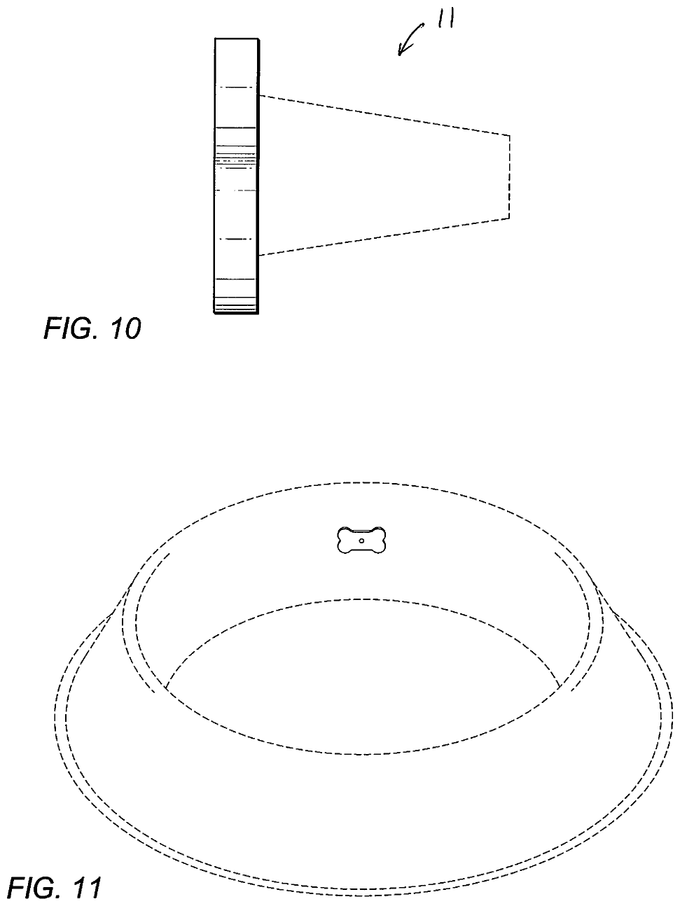

FIGS. 7-10 and 18-19 show a preferred embodiment of the emitter 11. The emitter is made of a resilient material such as rubber, thermoplastic polyester, thermoplastic polyurethane, acrylonitrile butadiene styrene, or polylactic acid. Since the emitter 11 will be submerged in the pet's drinking water and the pet may lick it, preferably a food-safe material is used. The emitter 11 comprises a stem 21 and a head, with a through hole 23 running therethrough. The stem 21 is a truncated cone having its base near the inlet 54 and its tip at the outlet 53. The inlet 54 of the stem 21 is sized to receive drip line in a leak-tight fit. Preferably the inlet 54 is sized to receive a male end of a standard drip line connector. The head of the emitter is a flange 32. The base of the cone of the stem is connected to the flange 32, optionally at a straight-walled neck 33. See FIGS. 10 and 18. The emitter 11 is inserted into the emitter aperture 30 in the sidewall 14 of the bowl 12 and the flange 32 effects the leak-tight seal against the sidewall of the bowl. The optional neck 33 may be sized the same as or slightly bigger than the emitter aperture 30 so that the resilient material compresses against the edge of the emitter aperture to form a leak-tight fit. The through hole 23 is a straight channel 24 in the stem 21 that narrows into a conical channel 25 as it approaches the outlet 53, such that the outlet 53 has a smaller diameter than the inlet 54. In the preferred embodiment, the flange 32 is shaped like a dog bone for ornamental purposes.

To keep a bowl steady, the bottom 13 of the bowl or the rim 18 of the apron needs to sit squarely on the floor or ground. For a bowl 12 with an apron 15, the drip line 40 may run through a hole in the apron 15 to prevent the bowl from sitting on the drip line and causing the bowl to be unsteady. For example, FIGS. 1-3 and 12 show a drip line exiting through a hole in the apron of the water bowl; a grommet 48 is disposed between the drip line 40 and the apron aperture. FIG. 13 shows the drip line exiting through a cutout in the apron rim 18.

In operation, the outlet 54 of the emitter is attachable to drip irrigation tubing, which conventionally is flexible ¼″ polyethylene tubing. The emitter can have a female inlet connectable to the drip line with a standard male connector, as in FIG. 18, or have a male inlet connectable directly to drip line, as in FIG. 15. The drip irrigation tubing is connected to a drip irrigation system having a control timer 4 connected to one or more on-off solenoid valves 5, typically in a valve box buried in the ground, as known the art. See FIG. 4. The control timer is connected to power—mains or battery—to turn the valves on and off. The drip irrigation system can be set to have water discharged from the emitter at any time of day, for any number of days, and for any duration. Ideally the bowl is in communication with its own valve, but can share the valve with other emitters, for example emitters that water plants.

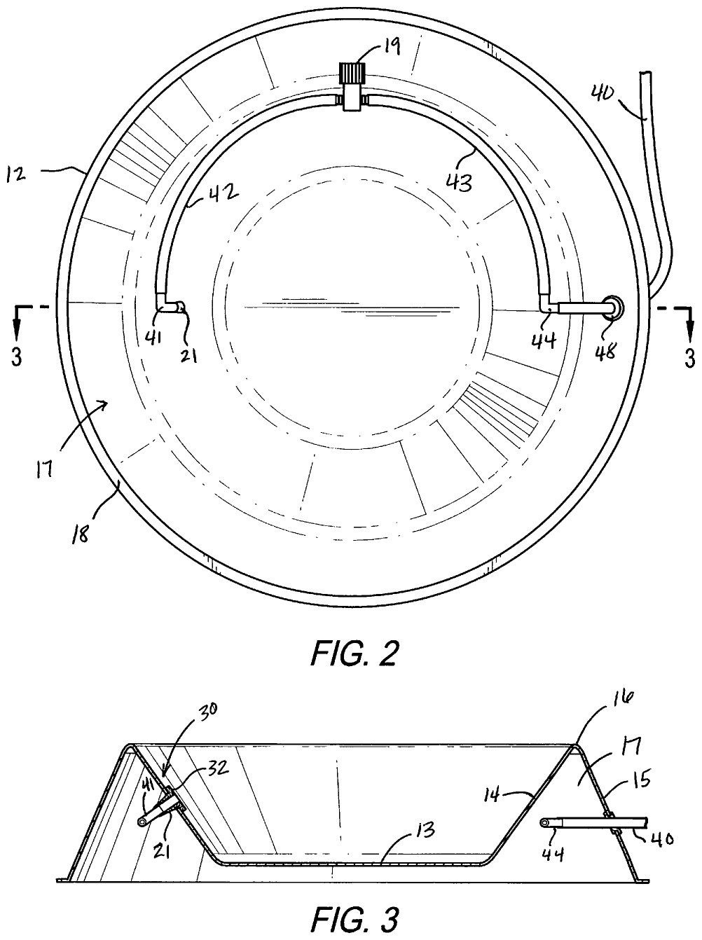

The frequency and length of time the timer 4 is set to dispense water into the bowl 12 will depend on a number of factors, including the pressure of the water at the inlet, the emitter output, how big the bowl is, evaporation, how thirsty the pets are, and how many times the bowl needs to be filled in a day. To help precisely set how the bowl is filled, an adjustable flow rate valve 19 may be connected to the drip line between the emitter 11 and the on-off valve 5. The adjustable flow rate valve 19 can reduce the amount of water reaching the emitter 11 from the drip line 40 and help fine tune the flow rate of water emitted into the bowl. In the preferred embodiment the adjustable flow rate valve 19 is attached to the drip line between the emitter 11 and the apron aperture and is disposed in the cavity 17. See FIG. 2. This hides the adjustable flow rate valve 19 and protects against pets trying to chew it.

FIG. 2 shows a preferred arrangement of the components. An emitter 11 (only stem 21 is shown) is disposed in the sidewall 14 of the bowl 12 in a leak-tight seal and connected to a first portion 42 of drip line with a first elbow 41. An adjustable flow-rate valve 19 is connected at its outlet to the first portion 42 of the drip line at a connector outlet barb and at its inlet to a second portion 43 of the drip line at a connector inlet barb. The second portion 43 of drip line is connected to a second elbow 44, which in turn is connected to the drip line 40 that connects to the drip irrigation system. The second elbow or drip line exits the apron through an aperture in the apron, preferably a hole in the apron. The edges of the hole are protected by a rubber grommet 48 to prevent the drip line from chafing against the sharp edges of the hole. The ends of the elbows and connectors are male and fit snugly in the inlet of the emitter and the several pieces of drip line. In one embodiment the elbows, connectors, adjustable flow-rate valve, and drip line are standard drip irrigation parts.

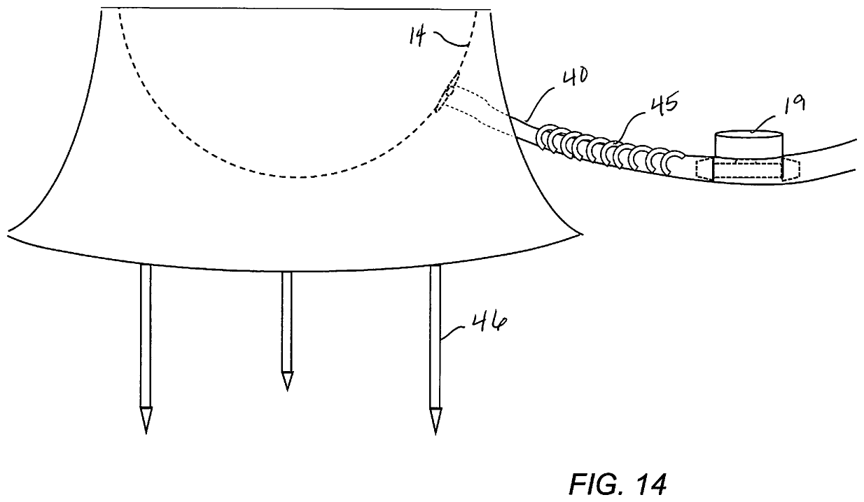

The bowl 12 may be anchored to the ground to further prevent skidding and tipping. In one embodiment straight spikes 46 extend from the rim 18 of the apron or the bottom 13 of the bowl, or from “ears” that are extensions extending from the rim or bottom of the bowl. See FIG. 14. The ears may serve to balance the bowl, as well. Alternatively, the spikes 46 may be separate from the bowl 12, disposed in openings in the rim 18 or ears. The spikes 46 are pushed or driven into the ground, anchoring the bowl in place. In another embodiment, a helical post extends from the rim, bottom, or ears. The bowl in then screwed into the ground, preferably before attaching it to the irrigation tubing running from the valve.

The irrigation tubing 40 may be covered by a helix 45 of metal or chew-resistant material to prevent animals from chewing through the portion of the irrigation tubing that remains above ground. See FIG. 14.

The bowl can be made of any material, including metal, glass, plastic, concrete and ceramics. In a preferred embodiment the bowl is made of clay or terra cotta earthenware so that, as, the bowl absorbs the water it helps the water remain cool. In another preferred embodiment the bowl has a shape and coloring similar to a water-retaining saucer that is put under a plant pot. This helps camouflage the bowl as a plant pot. In another embodiment the bowl is stainless steel.

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the appended claims.

We claim:

1. A water bowl comprising:
a. a bowl having a top edge without a recess or a scallop through which water can spill out of the bowl, a sidewall and a bottom;
b. an emitter aperture in the sidewall of the bowl;
c. an emitter having a through hole, the emitter disposed in the emitter aperture such that a leak-tight seal is formed at the intersection of the emitter and the sidewall of the bowl;
d. a drip line connected to the emitter, wherein the drip line is connectable to an on-off valve of a pressurized water source, the on-off valve operable by a control timer; and
e. an adjustable flow rate valve connected to the drip line between the emitter and the on-off valve.

2. The water bowl of claim 1 wherein the through hole wends a tortuous path.

3. The water bowl of claim 1 wherein the bowl further comprises an apron connected to the bowl at the top edge and the adjustable flow rate valve is disposed in a cavity formed between the apron and the sidewall of the bowl.

4. The water bowl of claim 1 wherein the emitter is made of a resilient material such that the emitter resiliently seals against the emitter aperture to form the leak-tight seal.

5. The water bowl of claim 1 wherein the emitter is molded into the bowl.

6. The water bowl of claim 1 wherein the emitter is adjustable to achieve a desired flow rate of water emitted into the bowl.

7. A water bowl comprising:
a. a bowl having a top edge, a sidewall, and a bottom;
b. an emitter disposed in the sidewall in a leak-tight seal, wherein the emitter is adjustable to achieve a desired flow rate of water emitted into the bowl; and
c. a drip line connected to the emitter, wherein the drip line is connectable to an on-off valve of a pressurized water source, the on-off valve operable by a control timer.

8. The water bowl of claim 7 wherein the emitter is molded into the bowl.

9. The water bowl of claim 7 wherein the through hole wends a tortuous path.

10. The water bowl of claim 7 wherein the bowl further comprises an adjustable flow rate valve connected to the drip line between the emitter and the on-off valve.

11. A water bowl comprising:
a. a bowl having a top edge without a recess or a scallop through which water can spill out of the bowl, a sidewall and a bottom; and
b. an emitter disposed in the sidewall in a leak-tight seal, the emitter comprising:
i. a stem connected to a head, wherein the stem is a truncated cone having a base and a tip, the base of the cone is connected to the head and the tip of the cone is configured to receive the drip line in a snug fit;
ii. a through hole running through the stem and the head; and
iii. the stem is configured to receive a drip line in a leak-tight fit.

12. The water bowl of claim 11 wherein the emitter is molded into the bowl.

13. The water bowl of claim 11 wherein the through hole wends a tortuous path.

14. The water bowl of claim 11 where the base is connected to the head at a neck.

15. The water bowl of claim 11 wherein the emitter is adjustable to achieve a desired flow rate of water emitted into the bowl.

16. The water bowl of claim 11 wherein the bowl further comprises an adjustable flow rate valve connected to the drip line between the emitter and the on-off valve.

17. A water bowl comprising:
a. a bowl having a top edge without a recess or a scallop through which water can spill out of the bowl, a sidewall and a bottom;
b. an apron connected to the bowl at the top edge forming a cavity between the apron and the sidewall of the bowl;
c. an emitter aperture in the sidewall of the bowl;
d. an emitter disposed in the emitter aperture, wherein:
i. the emitter is made of a resilient material and is disposed in the emitter aperture such that the emitter resiliently seals against the sidewall in a leak-tight seal at the intersection of the emitter and the sidewall of the bowl;
ii. the emitter further comprises a stem connected to a head, wherein the stem is a truncated cone having a base and a tip, the base of the cone is connected to the head and the tip of the cone is configured to receive the drip line in a snug fit; and
iii. the emitter has a through-hole that runs through the stem and head;
e. a drip line aperture in the apron;
f. a drip line connected to the emitter and running from the emitter through the drip line aperture, wherein the drip line is connectable to an on-off valve of a pressurized water source, the on-off valve operable by a control timer; and
g. an adjustable flow rate valve connected to the drip line between the emitter and the on-off valve wherein the adjustable flow rate valve is disposed in the cavity.

18. The water bowl of claim 17 where the base is connected to the head at a neck.

19. The water bowl of claim 17 wherein the through hole wends a tortuous path.

20. The water bowl of claim 17 wherein the emitter is adjustable to achieve a desired flow rate of water emitted into the bowl.
